(19) United States
(12) Patent Application Publication
(10) Pub. No.: US 2025/0225229 A1
(43) Pub. Date: Jul. 10, 2025

(54) INFORMATION PROCESSING SYSTEM, INFORMATION PROCESSING APPARATUS, AND INFORMATION PROCESSING METHOD

(71) Applicant: Lenovo (Singapore) Pte. Ltd., Singapore (SG)

(72) Inventors: Toyoharu Han, Kanagawa (JP); Mikio Hagiwara, Kanagawa (JP); Kazuya Shibayama, Kanagawa (JP); Dharmesh Rameshbhai Dhankecha, Kanagawa (JP)

(73) Assignee: Lenovo (Singapore) Pte. Ltd., Singapore (SG)

(21) Appl. No.: 19/017,283

(22) Filed: Jan. 10, 2025

(30) Foreign Application Priority Data
Jan. 10, 2024 (JP) 2024-001810

(51) Int. Cl. G06F 21/44; G06F 21/34; G06F 21/64

(52) U.S. Cl. CPC G06F 21/445; G06F 21/34; G06F 21/64

(57) ABSTRACT

An information processing system includes: an information processing apparatus that holds, out of a private key and a public key of public key cryptography assigned to the information processing apparatus, the public key, and is shipped in a locked state in which startup by an operating system (OS) is prohibited; and a higher-level apparatus connectable to the information processing apparatus via an interface of Universal Serial Bus (USB) Type-C. The information processing apparatus includes: a main control unit that executes processes based on the OS and Basic Input/Output System (BIOS); and a sub-control unit that is capable of operating in a state in which power is not supplied to the main control unit, and releases the locked state if mutual validity of the information processing apparatus and the higher-level apparatus is verified based on the private key and the public key using the USB Type-C.

### CROSS-REFERENCE TO RELATED APPLICATIONS

This application claims priority to Japanese Patent Application No. 2024-001810 filed on Jan. 10, 2024, the contents of which are hereby incorporated herein by reference in their entirety.

### TECHNICAL FIELD

The present invention relates to an information processing system, an information processing apparatus, and an information processing method.

### BACKGROUND

Information processing apparatuses such as personal computers (PCs) allow various setting changes by the Basic Input/Output System (BIOS). In such information processing apparatuses, a BIOS password is set to enable BIOS settings in order to improve security (see, for example, Japanese Unexamined Patent Application Publication No. 2010-152721).

However, conventional information processing apparatuses have, when a user purchases a new information processing apparatus such as a PC, the user perform BIOS settings individually. Since the BIOS setup menu is not locked from when the information processing apparatus is shipped to when the information processing apparatus is delivered to the user, there is a possibility that a third party changes BIOS settings or changes an operating system (OS) and other software functions.

### SUMMARY

One or more embodiments of the present invention provide an information processing system, an information processing apparatus, and an information processing method that can improve security.

In accordance with one or more embodiments of the present invention, an information processing system includes: an information processing apparatus that holds, out of a private key and a public key of public key cryptography assigned to the information processing apparatus, the public key, and is shipped in a locked state in which startup by an operating system (OS) is prohibited; and a higher-level apparatus connectable to the information processing apparatus via an interface of Universal Serial Bus (USB) Type-C, wherein the information processing apparatus includes: a main control unit that executes processes based on the OS and Basic Input/Output System (BIOS); and a sub-control unit that is capable of operating in a state in which power is not supplied to the main control unit, and releases the locked state if mutual validity of the information processing apparatus and the higher-level apparatus is verified based on the private key and the public key using the USB Type-C.

In accordance with one or more embodiments of the present invention, in the foregoing information processing system, the sub-control unit may further permit a process of setting the BIOS and a process of updating the BIOS if the mutual validity of the information processing apparatus and the higher-level apparatus is verified, and the higher-level apparatus may execute the process of setting the BIOS and the process of updating the BIOS for the information processing apparatus via the sub-control unit using the USB Type-C.

In accordance with one or more embodiments of the present invention, in the foregoing information processing system, in a mutual authentication process for verifying the mutual validity of the information processing apparatus and the higher-level apparatus, the sub-control unit may transmit first encrypted information obtained by encrypting information including a random number using the public key and a first hash value that is a hash value of the information including the random number to the higher-level apparatus using the USB Type-C, the higher-level apparatus may generate a second hash value that is a hash value of information obtained by decrypting the received first encrypted information using the private key, and determine that the information processing apparatus is valid if the received first hash value and the second hash value match, the higher-level apparatus may generate a digital signature based on predetermined information using the private key and transmit the digital signature to the sub-control unit using the USB Type-C, if the higher-level apparatus determines that the information processing apparatus is valid, and the sub-control unit may verify validity of the higher-level apparatus based on the received digital signature and the public key.

In accordance with one or more embodiments of the present invention, in the foregoing information processing system, the higher-level apparatus may generate the digital signature by encrypting a third hash value that is a hash value of the predetermined information using the private key, and the sub-control unit may determine that the higher-level apparatus is valid if the third hash value and a fourth hash value obtained by decrypting the received digital signature using the public key match.

In accordance with one or more embodiments of the present invention, in the foregoing information processing system, the higher-level apparatus and the sub-control unit may execute the mutual authentication process using a CC signal line of the USB Type-C.

In accordance with one or more embodiments of the present invention, in the foregoing information processing system, the mutual validity of the information processing apparatus and the higher-level apparatus may be verified based on the private key stored in a USB device connected to the higher-level apparatus and the public key held in the information processing apparatus.

In accordance with one or more embodiments of the present invention, in the foregoing information processing system, the mutual validity of the information processing apparatus and the higher-level apparatus may be verified based on the private key stored in a server apparatus connected to the higher-level apparatus via a network and the public key held in the information processing apparatus.

In accordance with one or more embodiments of the present invention, an information processing apparatus in an information processing system includes: the information processing apparatus that holds, out of a private key and a public key of public key cryptography assigned to the information processing apparatus, the public key, and is shipped in a locked state in which startup by an operating system (OS) is prohibited; and a higher-level apparatus connectable to the information processing apparatus via an interface of Universal Serial Bus (USB) Type-C, the information processing apparatus including: a main control unit that executes processes based on the OS and Basic Input/Output System (BIOS); and a sub-control unit that is capable of operating in a state in which power is not supplied to the main control unit, and releases the locked state if mutual validity of the information processing apparatus and the higher-level apparatus is verified based on the private key and the public key using the USB Type-C.

In accordance with one or more embodiments of the present invention, an information processing method of an information processing system includes: an information processing apparatus including a main control unit that executes processes based on an operating system (OS) and Basic Input/Output System (BIOS) and a sub-control unit capable of operating in a state in which power is not supplied to the main control unit; and a higher-level apparatus connectable to the information processing apparatus via an interface of Universal Serial Bus (USB) Type-C, the information processing method including: a step in which the information processing apparatus holds, out of a private key and a public key of public key cryptography assigned to the information processing apparatus, the public key, and is shipped in a locked state in which startup by the OS is prohibited; a step in which the information processing apparatus is connected to the higher-level apparatus via the interface of the USB Type-C; and a step in which the sub-control unit releases the locked state if mutual validity of the information processing apparatus and the higher-level apparatus is verified based on the private key and the public key using the USB Type-C.

One or more embodiments of the present invention can improve security.

### BRIEF DESCRIPTION OF THE DRAWINGS

FIG. 1 is a schematic diagram illustrating an example of an information processing system according to one or more embodiments.

FIG. 2 is a block diagram illustrating an example of the main hardware structure of a laptop PC according to one or more embodiments.

FIG. 3 is a functional block diagram illustrating an example of the functional structure of the information processing system according to one or more embodiments.

FIG. 4 is a diagram illustrating an example of data in a registration information storage unit according to one or more embodiments.

FIG. 5 is a diagram illustrating an example of a locked state release process in the information processing system according to one or more embodiments.

FIG. 6 is a diagram illustrating an example of a BIOS update process in the information processing system according to one or more embodiments.

FIG. 7 is a diagram illustrating another example of a locked state release process in the information processing system according to one or more embodiments.

### DETAILED DESCRIPTION

An information processing system, information processing apparatus, and information processing method according to one or more embodiments of the present invention will be described below with reference to drawings.

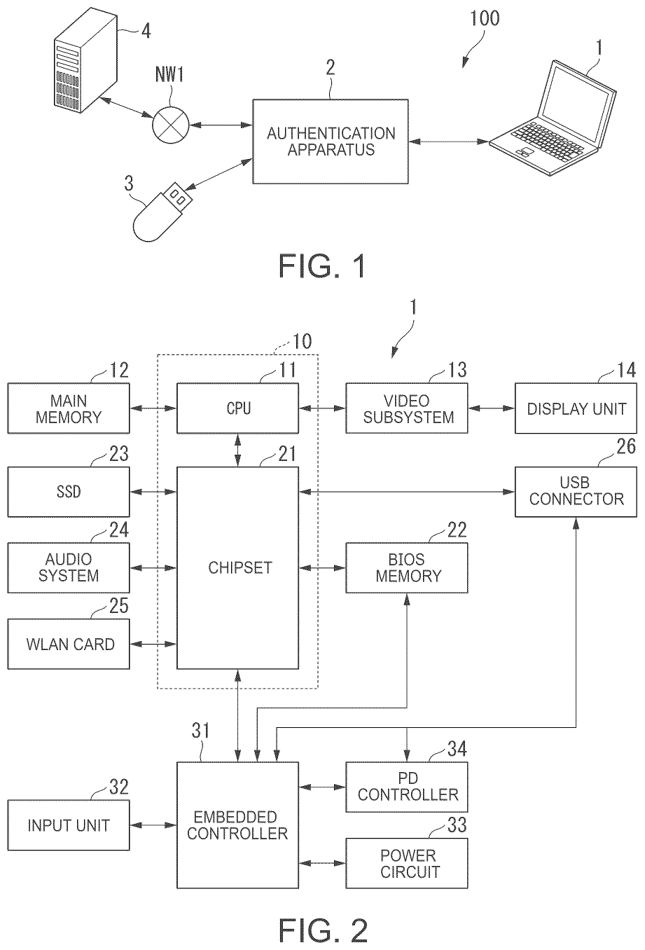

FIG. 1 is a schematic diagram illustrating an example of an information processing system 100 according to one or more embodiments.

As illustrated in FIG. 1, the information processing system 100 includes a laptop PC 1, an authentication apparatus 2, a Universal Serial Bus (USB) device 3, and a management server 4.

The laptop PC 1 and the authentication apparatus 2 are connected by a USB Type-C (USB-C) interface.

The authentication apparatus 2 and the management server 4 are connected via a network NW1.

In one or more embodiments, the laptop PC 1 will be described as an example of an information processing apparatus.

The laptop PC 1 holds, out of a private key and a public key of public key cryptography assigned to the laptop PC 1, the public key, and is shipped in a locked state in which startup by an OS is prohibited. The structure of the laptop PC 1 will be described in detail later with reference to FIG. 2.

The authentication apparatus 2 (an example of a higher-level apparatus) is an apparatus connectable to the laptop PC 1 via the USB Type-C interface, and executes a process of releasing the locked state of the laptop PC 1, a BIOS setting process, and a BIOS program update process. The authentication apparatus 2 is, for example, a laptop PC or a desktop PC. The authentication apparatus 2 is also connectable to the USB device or the management server 4 that holds the private key, in order to execute a process of mutual authentication with the laptop PC 1.

The USB device 3 is a device connectable to the authentication apparatus 2 via a USB interface (for example, USB Type-A). The USB device 3 holds the private key corresponding to the laptop PC 1, and is used for the process of releasing the locked state of the shipped laptop PC 1, the BIOS setting process, and the BIOS program update process.

The management server 4 is, for example, a server apparatus managed by the manufacturer of the laptop PC 1, and is connectable to the authentication apparatus 2 via the network NW1. The management server 4 holds the private key and public key corresponding to each laptop PC 1. The management server 4 is used for the process of releasing the locked state of the shipped laptop PC 1, the BIOS setting process, and the BIOS program update process, as with the USB device 3.

Next, the main hardware structure of the laptop PC 1 will be described with reference to FIG. 2. FIG. 2 is a diagram illustrating an example of the main hardware structure of the laptop PC 1 according to one or more embodiments.

As illustrated in FIG. 2, the laptop PC 1 includes a central processing unit (CPU) 11, a main memory 12, a video subsystem 13, a display unit 14, a chipset 21, a BIOS memory 22, a solid state drive (SSD) 23, an audio system 24, a wireless local area network (WLAN) card 25, a USB connector 26, an embedded controller 31, an input unit 32, a power circuit 33, and a Power Delivery (PD) controller 34.

In one or more embodiments, the CPU 11 and the chipset 21 correspond to a main control unit 10. The main control unit 10 is an example of a processor (main processor) that executes programs stored in memory (main memory 12).

The CPU 11 performs various arithmetic processing by program control, and controls the overall laptop PC 1.

The main memory 12 is a writable memory used as an area for reading execution programs of the CPU 11 or a work area for writing processed data of the execution programs. For example, the main memory 12 is made up of a plurality of dynamic random access memory (DRAM) chips. The execution programs include the BIOS, the OS, various drivers for operating hardware of peripherals, various services/utilities, application programs, and the like.

The main memory 12 is an example of a system memory that stores programs and data, and is installed in the laptop PC 1 by a DIMM including a plurality of DRAMs.

The video subsystem 13 is a subsystem for implementing functions relating to image display, and includes a video controller. The video controller processes a drawing instruction from the CPU 11, and writes the processed drawing information to a video memory. The video controller also reads the drawing information from the video memory, and outputs it to the display unit 14 as drawing data (display data).

The display unit 14 is, for example, a liquid crystal display, and displays a display screen based on the drawing data (display data) output from the video subsystem 13.

The chipset 21 includes controllers such as USB, Serial AT Attachment (ATA), Serial Peripheral Interface (SPI) bus, Peripheral Component Interconnect (PCI) bus, PCI-Express bus, and Low Pin Count (LPC) bus, and is connected to a plurality of devices. In FIG. 2, devices such as the BIOS memory 22, the SSD 23, the audio system 24, the WLAN card 25, and the USB connector 26 are connected to the chipset 21.

The BIOS memory 22 is, for example, composed of an electrically rewritable non-volatile memory such as electrically erasable programmable read only memory (EEPROM) or flash ROM. The BIOS memory 22 stores the BIOS, system firmware for controlling the embedded controller 31, etc., and the like.

The SSD 23 (an example of a nonvolatile storage device) stores the OS, various drivers, various services/utilities, application programs, and various data.

The audio system 24 records, reproduces, and outputs sound data.

The WLAN card 25 connects to a network by wireless LAN and performs data communication.

The USB connector 26 is a connector for connecting peripherals using USB. The USB connector 26 includes, for example, a USB Type-C connector.

The embedded controller 31 (an example of a sub-control unit) is a one-chip microcomputer that monitors and controls each device (peripherals, sensors, etc.) regardless of the system state of the laptop PC 1. The embedded controller 31 also has a power management function of controlling the power circuit 33. The embedded controller 31 is composed of a CPU, a ROM, a RAM, and the like (not illustrated), and includes A/D input terminals, D/A output terminals, timers, and digital input and output terminals of a plurality of channels. The embedded controller 31 is connected to the input unit 32, the power circuit 33, and the like via these input and output terminals, and controls their operations.

The embedded controller 31 is capable of operating in a state in which no power is supplied to the main control unit 10, and can communicate with the authentication apparatus 2 using USB Type-C without involving the main control unit 10 and can access the BIOS memory 22 without involving the main control unit 10.

The input unit 32 is an input device such as a keyboard, a pointing device, or a touchpad.

The power circuit 33 includes, for example, a DC/DC converter, a charge/discharge unit, a battery unit, and an AC/DC adapter, and converts a DC voltage supplied from the AC/DC adapter or the battery unit into a plurality of voltages necessary to operate the laptop PC 1. The power circuit 33 supplies power to each unit in the laptop PC 1, based on control by the embedded controller 31.

The PD controller 34 communicates with a device connected to the USB connector 26 (for example, a USB Type-C connector) and performs control of power supply or power reception to or from the device. If a device is connected to the USB connector 26, the PD controller 34 detects the connection of the device and acquires or determines information about the connected device (device attribute information) via a configuration channel (CC) terminal or the like. For example, based on communication with the device connected to the USB connector 26 via the CC terminal, the PD controller 34 acquires or determines information about compatibility with the USB-PD standard, information indicating whether one or both of power supply and power reception are supported if the device is compatible with the USB-PD standard, information about compatibility with data communication, information about compatibility with the USB BC 1.2 standard, and the like.

In one or more embodiments, the PD controller 34 enables communication between the authentication apparatus 2 and the embedded controller 31 using a USB Type-C CC signal line.

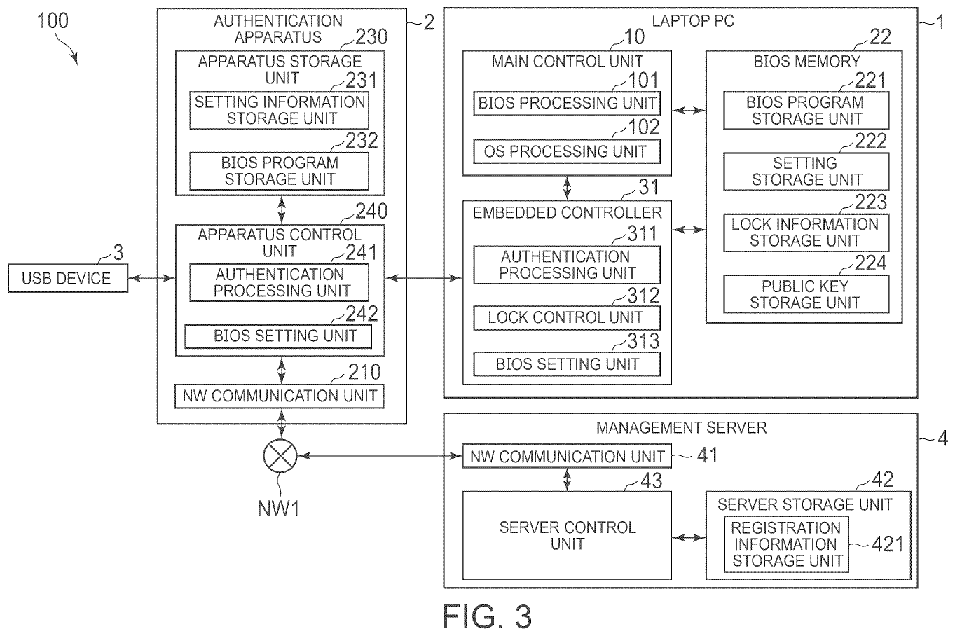

Next, the functional structure of the information processing system 100 according to one or more embodiments will be described with reference to FIG. 3.

FIG. 3 is a functional block diagram illustrating an example of the functional structure of the information processing system 100 according to one or more embodiments. FIG. 3 illustrates only the components related to the present invention among various functional components of the information processing system 100.

As illustrated in FIG. 3, the information processing system 100 includes the laptop PC 1, the authentication apparatus 2, the USB device 3, and the management server 4.

The management server 4 includes a network (NW) communication unit 41, a server storage unit 42, and a server control unit 43.

The NW communication unit 41 is a network adapter connectable to the network NW1 by, for example, a wired LAN, and is connectable to the authentication apparatus 2 via the network NW1.

The server storage unit 42 is a storage unit implemented, for example, by a RAM, SSD, or HDD, and stores various information used by the management server 4. The server storage unit 42 includes a registration information storage unit 421.

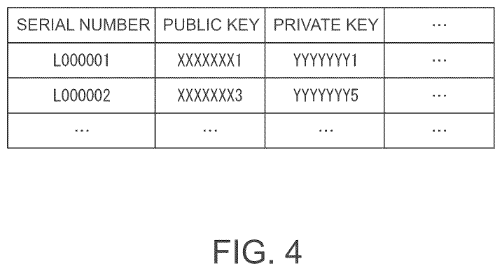

The registration information storage unit 421 stores registration information of each laptop PC 1 manufactured and shipped by the manufacturer. For example, the registration information storage unit 421 stores the serial number, public key, and private key of each laptop PC 1 in association with each other, as illustrated in FIG. 4.

The serial number is an example of identification information for identifying the laptop PC 1. The public key and the private key are a key pair (public and private keys) of public key cryptography assigned to the laptop PC 1. In one or more embodiments, one key pair is assigned to one laptop PC 1.

In the example illustrated in FIG. 4, a laptop PC 1 with a serial number “L000001” is assigned a public key “XXXXXXX1” and a private key “YYYYYYY1”.

Referring back to FIG. 3, the server control unit 43 is a functional unit implemented, for example, by causing a CPU (not illustrated) to execute programs stored in the server storage unit 42. The server control unit 43 executes a process of registering a serial number, public key, and private key stored in the registration information storage unit 421 and an encryption process and decryption process for authentication during an authentication process between the laptop PC 1 and the authentication apparatus 2.

The laptop PC 1 includes the main control unit 10, the BIOS memory 22, and the embedded controller 31.

The BIOS memory 22 includes a BIOS program storage unit 221, a setting storage unit 222, a lock information storage unit 223, and a public key storage unit 224. The BIOS memory 22 is accessible from the embedded controller 31 via an SPI bus.

The BIOS program storage unit 221 stores a BIOS program.

The setting storage unit 222 stores BIOS setting information including a BIOS password.

The lock information storage unit 223 stores information indicating whether the laptop PC 1 is in the locked state. When the laptop PC 1 is shipped, information indicating the locked state is stored in the lock information storage unit 223.

The public key storage unit 224 stores the public key assigned to the laptop PC 1. The public key storage unit 224 may store the public key in association with the serial number of the laptop PC 1.

The main control unit 10 is a functional unit implemented by causing the CPU 11 to execute programs stored in the SSD 23, the BIOS memory 22, the main memory 12, etc. The main control unit 10 executes processes based on the OS and the BIOS. The main control unit 10 includes, for example, a BIOS processing unit 101 and an OS processing unit 102.

The BIOS processing unit 101 is a functional unit implemented, for example, by causing the CPU 11 to execute the BIOS program stored in the BIOS memory 22, and executes processes based on the BIOS.

The OS processing unit 102 is a functional unit implemented, for example, by causing the CPU 11 to execute the OS program stored in the SSD 23, and executes processes based on the OS.

The embedded controller 31 is a control unit capable of operating in a state in which power is not supplied to the main control unit 10, and releases the locked state of the laptop PC 1 if the mutual validity of the laptop PC 1 and the authentication apparatus 2 is verified based on the private key and public key using USB Type-C. The embedded controller 31 also permits the BIOS setting process and the BIOS update process if the mutual validity of the laptop PC 1 and the authentication apparatus 2 is verified.

The embedded controller 31 includes an authentication processing unit 311, a lock control unit 312, and a BIOS setting unit 313.

The authentication processing unit 311 executes an authentication process for verifying the mutual validity of the embedded controller 31 (laptop PC 1) and the authentication apparatus 2 using the USB Type-C CC signal line. The authentication processing unit 311 first generates a random number (for example, a pseudorandom number using software), and encrypts information including the generated random number (for example, a character string of the random number) by public key cryptography using the public key stored in the public key storage unit 224. The authentication processing unit 311 also generates a hash value (first hash value) of the information including the generated random number (for example, the character string of the random number) using a hash function.

The authentication processing unit 311 transmits encrypted information (first encrypted information) obtained by encrypting the information including the random number and the hash value (first hash value) to the authentication apparatus 2 using the USB Type-C CC signal line. The authentication processing unit 311 may transmit the serial number of the laptop PC 1 to the authentication apparatus 2 in advance.

Moreover, the authentication processing unit 311 verifies the validity of the authentication apparatus 2 based on a digital signature received from the authentication apparatus 2 and the public key using the USB Type-C CC signal line. For example, the authentication processing unit 311 verifies the validity of the authentication apparatus 2 by determining whether a hash value generated by decrypting the digital signature using the public key stored in the public key storage unit 224 and a hash value generated from message data (predetermined information) match.

Here, if the authentication apparatus 2 verifies the validity of the laptop PC 1 (embedded controller 31), the authentication apparatus 2 transmits the digital signature.

The lock control unit 312 releases the locked state of the laptop PC 1 if the authentication processing unit 311 verifies the validity of the authentication apparatus 2. The lock control unit 312 changes the information indicating whether the laptop PC 1 is in the locked state, which is stored in the lock information storage unit 223, to information indicating that the laptop PC 1 is not in the locked state, to release the locked state.

The BIOS setting unit 313 permits the BIOS setting process and the BIOS update process if the authentication processing unit 311 verifies the validity of the authentication apparatus 2. In the BIOS setting process, the BIOS setting unit 313 stores BIOS setting information received from the authentication apparatus 2 in the setting storage unit 222 to change the BIOS settings. The BIOS setting information includes a BIOS password, etc.

In the BIOS update process, the BIOS setting unit 313 stores a BIOS program received from the authentication apparatus 2 in the BIOS program storage unit 221 to update the BIOS. The BIOS update process also includes a patch process of updating part of the BIOS program, etc.

The authentication apparatus 2 includes a NW communication unit 210, an apparatus storage unit 230, and an apparatus control unit 240.

The NW communication unit 210 is a network adapter connectable to the network NW1 by, for example, a wired LAN or a wireless LAN, and is connectable to the management server 4 via the network NW1.

The apparatus storage unit 230 is a storage unit implemented, for example, by a RAM, SSD, or HDD, and stores various information used by the authentication apparatus 2. The apparatus storage unit 230 includes a setting information storage unit 231 and a BIOS program storage unit 232.

The setting information storage unit 231 stores BIOS setting information acquired from the management server 4 or the USB device 3.

The BIOS program storage unit 232 stores a BIOS update program acquired from the management server 4 or the USB device 3.

The apparatus control unit 240 is a functional unit implemented, for example, by causing a CPU (not illustrated) to execute programs stored in the apparatus storage unit 230. The apparatus control unit 240 performs various processes to be executed by the authentication apparatus 2.

For example, the apparatus control unit 240 executes the authentication process with the laptop PC 1 and also controls the BIOS setting process and BIOS update process in the laptop PC 1. The apparatus control unit 240 executes the BIOS setting process and the BIOS update process for the laptop PC 1 via the embedded controller 31 using USB Type-C.

The apparatus control unit 240 includes an authentication processing unit 241 and a BIOS setting unit 242.

The authentication processing unit 241 controls the authentication process with the embedded controller 31 (laptop PC 1) using the USB Type-C CC signal line. Having received the encrypted information obtained by encrypting the information including the random number and the hash value (first hash value) from the embedded controller 31 using the USB Type-C CC signal line, the authentication processing unit 241 transmits a request to decrypt the encrypted information using the private key corresponding to the laptop PC 1 to the management server 4 via the network NW1.

The authentication processing unit 241 also receives information obtained by decrypting the encrypted information (first encrypted information) from the management server 4 via the network NW1, and generates a hash value (second hash value) of the received information (information obtained by decrypting the encrypted information using the private key). If the hash value (first hash value) received from the laptop PC 1 and the generated hash value (second hash value) match, the authentication processing unit 241 determines that the laptop PC 1 is valid.

If the authentication processing unit 241 determines that the laptop PC 1 is valid, the authentication processing unit 241 generates a digital signature based on the predetermined information using the private key corresponding to the laptop PC 1, and transmits the digital signature to the embedded controller 31 using USB Type-C. The authentication processing unit 241 generates the digital signature by encrypting a hash value (third hash value), which is a hash value of the predetermined information, using the private key.

Specifically, the authentication processing unit 241 generates the hash value (third hash value) of the predetermined information (for example, random number+α), and transmits the generated hash value (third hash value) to the management server 4 to request encryption using the private key corresponding to the laptop PC 1. The authentication processing unit 241 transmits the encrypted hash value as the digital signature to the embedded controller 31 (laptop PC 1) together with the predetermined information (message data), using the USB Type-C CC signal line.

The embedded controller 31 determines that the authentication apparatus 2 is valid if the hash value (third hash value) of the predetermined information (message data) generated by the embedded controller 31 and a hash value (fourth hash value) obtained by decrypting the received digital signature using the public key match, as described above.

The BIOS setting unit 242 executes the BIOS setting process and the BIOS update process after the authentication processing unit 241 executes the authentication process. For example, if the validity of the laptop PC 1 (embedded controller 31) is verified by the authentication process, the BIOS setting unit 242 transmits the BIOS setting information stored in the setting information storage unit 231 to the embedded controller 31 using USB Type-C, to cause the embedded controller 31 to change its BIOS setting information.

Moreover, for example, if the validity of the laptop PC 1 (embedded controller 31) is verified by the authentication process, the BIOS setting unit 242 transmits the BIOS program stored in the BIOS program storage unit 232 to the embedded controller 31 using USB Type-C, to cause the embedded controller 31 to update the BIOS.

Although the above describes an example in which the management server 4 decrypts the encrypted information and generates the digital signature using the private key, instead of the management server 4, the USB device 3 may execute the same processes as the management server 4. For example, if the authentication apparatus 2 cannot connect to the network NW1, the information processing system 100 executes the locked state release process, the BIOS setting process, and the BIOS update process using the USB device 3.

Next, the operation of the information processing system 100 according to one or more embodiments will be described with reference to drawings.

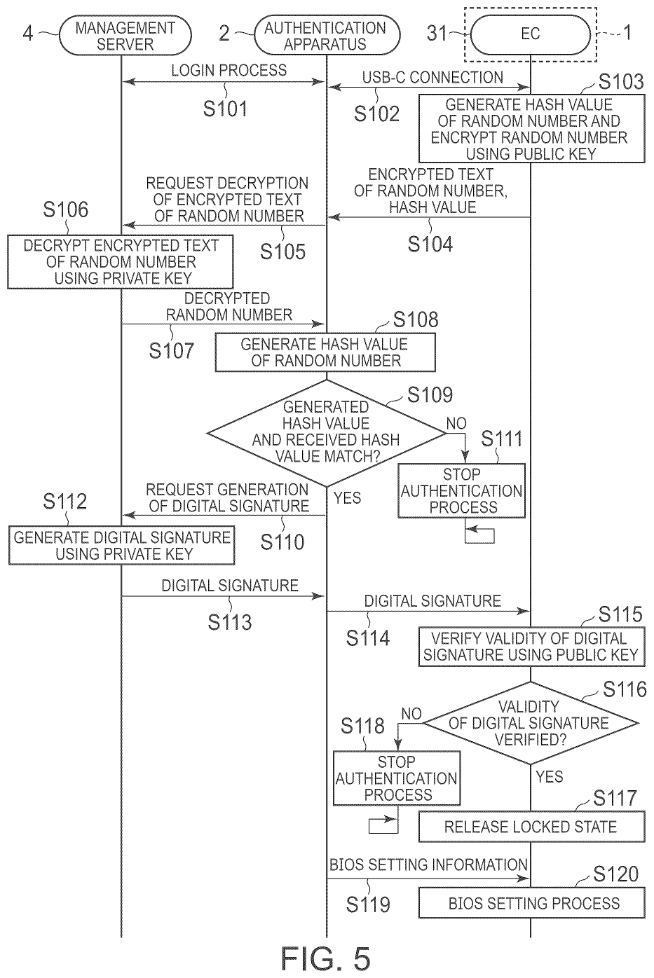

FIG. 5 is a diagram illustrating an example of the locked state release process in the information processing system 100 according to one or more embodiments.

As illustrated in FIG. 5, first, the authentication apparatus 2 executes a login process with the management server 4 (step S101). The apparatus control unit 240 in the authentication apparatus 2 transmits a user ID and a password to the management server 4 via the NW communication unit 210, thus enabling access to the management server 4.

Next, the authentication apparatus 2 connects to the laptop PC 1 (embedded controller (EC) 31) using USB-C (USB Type-C) (step S102). The authentication apparatus 2 connects to the embedded controller 31 via the PD controller 34 using the CC signal line. Here, the laptop PC 1 is in a state in which the main control unit 10 is not supplied with power from the power circuit 33 whereas the embedded controller 31, the BIOS memory 22, and the PD controller 34 are supplied with power from the power circuit 33.

Next, the embedded controller 31 generates a hash value of a random number and encrypts the generated random number using the public key (step S103). For example, the authentication processing unit 311 in the embedded controller 31 generates the hash value (first hash value) of the random number and encrypts the random number using the public key stored in the public key storage unit 224 to generate encrypted information.

Next, the embedded controller 31 transmits the encrypted text of the random number (encrypted information) and the hash value (first hash value) to the authentication apparatus 2 (step S104). The authentication processing unit 311 transmits the encrypted information and the hash value (first hash value) to the authentication apparatus 2 using the CC signal line.

Next, the authentication apparatus 2 requests the management server 4 to decrypt the encrypted text of the random number (encrypted information) (step S105). The authentication processing unit 241 in the authentication apparatus 2 transmits a decryption request to request decryption of the encrypted information received from the embedded controller 31, to the management server 4 via the NW communication unit 210.

Next, the management server 4 decrypts the encrypted text of the random number (encrypted information) using the private key (step S106). The server control unit 43 in the management server 4 acquires the private key corresponding to the laptop PC 1 from the registration information storage unit 421, and decrypts the encrypted information received from the authentication apparatus 2 using the private key. The decrypted encrypted information corresponds to the random number.

Next, the management server 4 transmits the decrypted random number (decrypted text) to the authentication apparatus 2 (step S107). The server control unit 43 transmits the decrypted random number (decrypted text) to the authentication apparatus 2 via the NW communication unit 41.

Next, the authentication apparatus 2 generates a hash value (second hash value) of the received random number (decrypted text) (step S108). The authentication processing unit 241 receives the random number (decrypted text) from the management server 4 via the NW communication unit 210, and generates the hash value (second hash value) of the random number (decrypted text).

Next, the authentication processing unit 241 in the authentication apparatus 2 determines whether the generated hash value (second hash value) and the hash value (first hash value) received from the embedded controller 31 match (step S109). If the hash value (second hash value) and the hash value (first hash value) match (step S109: YES), the authentication processing unit 241 advances to step S110. If the hash value (second hash value) and the hash value (first hash value) do not match (step S109: NO), the authentication processing unit 241 advances to step S111 to stop the authentication process.

In step S110, the authentication processing unit 241 in the authentication apparatus 2 requests the management server 4 to generate a digital signature. The authentication processing unit 241 generates a hash value (third hash value) of predetermined information (for example, random number+a), and transmits the hash value (third hash value) to the management server 4 via the NW communication unit 210.

Next, the management server 4 generates a digital signature using the private key corresponding to the laptop PC 1 (step S112). The server control unit 43 receives the hash value (third hash value) from the authentication apparatus 2 via the NW communication unit 41, and acquires the private key corresponding to the laptop PC 1 from the registration information storage unit 421. The server control unit 43 encrypts the received hash value (third hash value) using the private key to generate the digital signature.

Next, the server control unit 43 in the management server 4 transmits the generated digital signature to the authentication apparatus 2 via the NW communication unit 41 (step S113).

Next, the authentication processing unit 241 in the authentication apparatus 2 transmits the digital signature to the embedded controller 31 together with the predetermined information (for example, random number+a), using the CC signal line (step S114).

Next, the authentication processing unit 311 in the embedded controller 31 verifies the validity of the digital signature using the public key (step S115). The authentication processing unit 311 decrypts the received digital signature using the public key stored in the public key storage unit 224 to generate a hash value (fourth hash value). The authentication processing unit 311 verifies the validity of the digital signature depending on whether the hash value (third hash value) of the predetermined information (for example, random number+a) and the hash value (fourth hash value) match.

Next, the authentication processing unit 311 in the embedded controller 31 determines whether the validity of the digital signature is verified (step S116). If the validity of the digital signature is verified (i.e. the hash value (third hash value) and the hash value (fourth hash value) match) (step S116: YES), the authentication processing unit 311 advances to step S117. If the validity of the digital signature is not verified (i.e. the hash value (third hash value) and the hash value (fourth hash value) do not match) (step S116: NO), the authentication processing unit 311 advances to step S118 to stop the authentication process.

In step S117, the embedded controller 31 releases the locked state. The lock control unit 312 in the embedded controller 31 changes the information indicating whether the laptop PC 1 is in the locked state, which is stored in the lock information storage unit 223, to information indicating that the laptop PC 1 is not in the locked state, to release the locked state. Moreover, the BIOS setting unit 313 in the embedded controller 31 permits the BIOS setting process and the BIOS update process.

Next, the authentication apparatus 2 transmits BIOS setting information to the embedded controller 31 (step S119). The BIOS setting unit 242 in the authentication apparatus 2 transmits the BIOS setting information stored in the setting information storage unit 231 to the embedded controller 31 using the CC signal line.

Next, the embedded controller 31 executes the BIOS setting process (step S120). The BIOS setting unit 313 in the embedded controller 31 stores the received BIOS setting information in the setting storage unit 222 to change the BIOS settings.

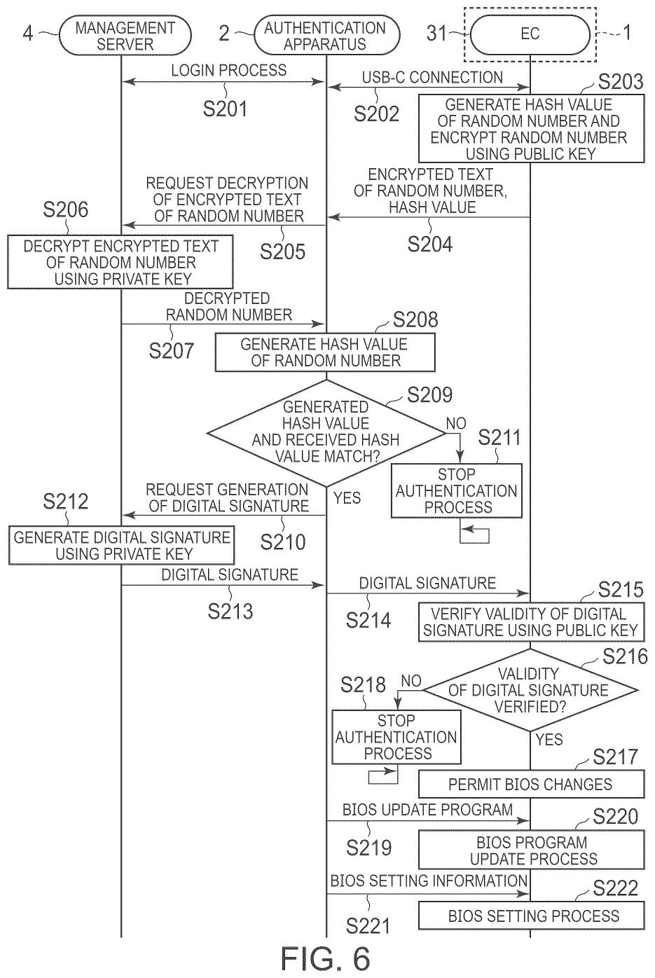

Next, the BIOS update process in the information processing system 100 according to one or more embodiments will be described with reference to FIG. 6.

FIG. 6 is a diagram illustrating an example of the BIOS update process in the information processing system 100 according to one or more embodiments.

The processes from steps S201 to S216 in FIG. 6 are the same as the processes from steps S101 to S116 in FIG. 5 described above, and accordingly their description will be omitted here.

In step S216, if the validity of the digital signature is verified (i.e. the hash value (third hash value) and the hash value (fourth hash value) match) (step S216: YES), the authentication processing unit 311 advances to step S217. If the validity of the digital signature is not verified (i.e. the hash value (third hash value) and the hash value (fourth hash value) do not match) (step S216: NO), the authentication processing unit 311 advances to step S218 to stop the authentication process.

In step S217, the embedded controller 31 permits BIOS changes. The BIOS setting unit 313 in the embedded controller 31 permits the BIOS setting process and the BIOS update process.

Next, the authentication apparatus 2 transmits a BIOS update program to the embedded controller 31 (step S219). The BIOS setting unit 242 in the authentication apparatus 2 transmits the BIOS program stored in the BIOS program storage unit 232 to the embedded controller 31 as a BIOS update program, using the CC signal line.

Next, the embedded controller 31 executes the BIOS program update process (step S220). The BIOS setting unit 313 in the embedded controller 31 stores the received BIOS update program in the BIOS program storage unit 221 to update the BIOS program.

Next, the authentication apparatus 2 transmits BIOS setting information to the embedded controller 31 (step S221). The BIOS setting unit 242 in the authentication apparatus 2 transmits the BIOS setting information stored in the setting information storage unit 231 to the embedded controller 31 using the CC signal line.

Next, the embedded controller 31 executes the BIOS setting process (step S222). The BIOS setting unit 313 in the embedded controller 31 stores the received BIOS setting information in the setting storage unit 222 to change the BIOS settings.

Although the management server 4 is used in the foregoing examples illustrated in FIGS. 5 and 6, in an environment where the authentication apparatus 2 cannot connect to the network NW1, the USB device 3 may be used instead of the management server 4.

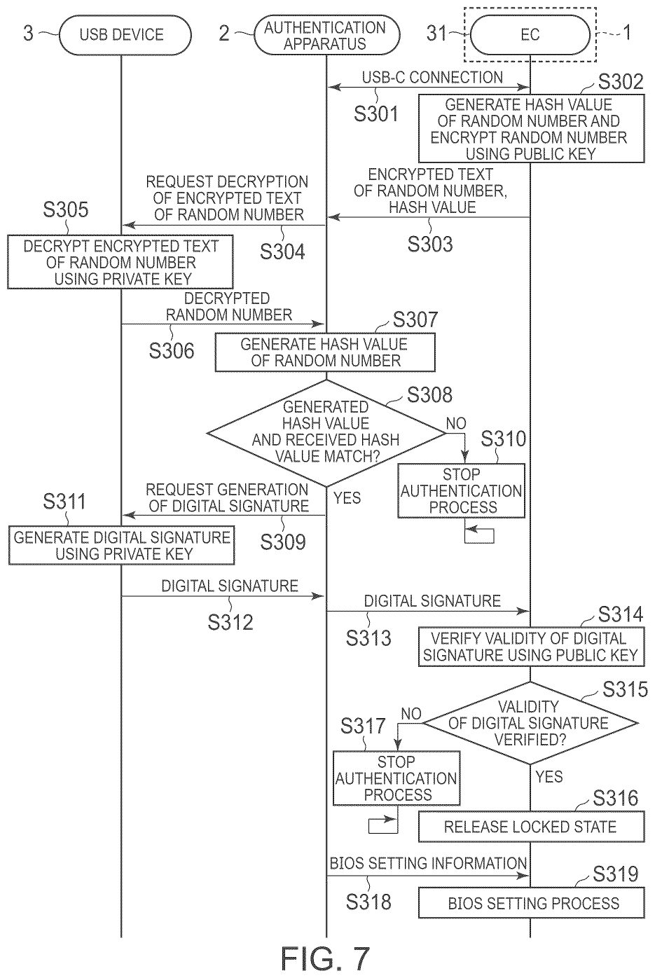

An example of the locked state release process in the case of using the USB device 3 will be described below with reference to FIG. 7.

FIG. 7 is a diagram illustrating another example of the locked state release process in the information processing system 100 according to one or more embodiments.

The processes from steps S301 to S303 in FIG. 7 are the same as the processes from steps S102 to S104 in FIG. 5 described above, and accordingly their description will be omitted here.

In step S304, the authentication apparatus 2 requests the USB device 3 to decrypt the encrypted text of the random number (encrypted information). The authentication processing unit 241 in the authentication apparatus 2 transmits a decryption request to request decryption of the encrypted information received from the embedded controller 31, to the USB device 3.

Next, the USB device 3 decrypts the encrypted text of the random number (encrypted information) using the private key (step S305). The USB device 3 decrypts the encrypted information received from the authentication apparatus 2 using the private key corresponding to the laptop PC 1. The decrypted encrypted information corresponds to the random number.

Next, the USB device 3 transmits the decrypted random number (decrypted text) to the authentication apparatus 2 (step S306).

The processes in steps S307 and S308 which follow are the same as the processes in steps S108 and S109 in FIG. 5 described above, and accordingly their description will be omitted here.

In step S308, if the hash value (second hash value) and the hash value (first hash value) match (step S308: YES), the authentication processing unit 241 advances to step S309. If the hash value (second hash value) and the hash value (first hash value) do not match (step S308: NO), the authentication processing unit 241 advances to step S310 to stop the authentication process.

In step S309, the authentication processing unit 241 in the authentication apparatus 2 requests the USB device 3 to generate a digital signature. The authentication processing unit 241 generates a hash value (third hash value) of predetermined information (for example, random number+a), and transmits the hash value (third hash value) to the USB device 3.

Next, the USB device 3 generates a digital signature using the private key corresponding to the laptop PC 1 (step S311). The USB device 3 encrypts the received hash value (third hash value) using the private key to generate the digital signature.

Next, the USB device 3 transmits the generated digital signature to the authentication apparatus 2 (step S312).

The processes in steps S313 to S319 which follow are the same as the processes in steps S114 to S120 in FIG. 5 described above, and accordingly their description will be omitted here.

While the locked state release process is performed using the USB device 3 in the foregoing example illustrated in FIG. 7, the BIOS update process illustrated in FIG. 6 described above may also be performed using the USB device 3.

As described above, the information processing system 100 according to one or more embodiments includes the laptop PC 1 (information processing apparatus) and the authentication apparatus 2 (higher-level apparatus). The laptop PC 1 holds, out of a private key and a public key of public key cryptography assigned to the laptop PC 1, the public key, and is shipped in a locked state in which startup by an OS is prohibited. The authentication apparatus 2 is connectable to the laptop PC 1 via a USB Type-C interface. The laptop PC 1 includes the main control unit 10 and the embedded controller 31 (sub-control unit). The main control unit 10 executes processes based on the OS and BIOS. The embedded controller 31 is a sub-control unit capable of operating in a state in which power is not supplied to the main control unit 10, and releases the locked state if the mutual validity of the laptop PC 1 and the authentication apparatus 2 is verified based on the private key and the public key using USB Type-C.

Thus, the information processing system 100 according to one or more embodiments releases the locked state if the mutual validity of the laptop PC 1 and the authentication apparatus 2 is verified, thereby improving security. The information processing system 100 according to one or more embodiments can reduce the possibility that the BIOS settings or the OS and other software functions are changed by a third party, for example.

Moreover, in the information processing system 100 according to one or more embodiments, the embedded controller 31 (sub-controller) capable of operating in a state in which power is not supplied to the main control unit 10 releases the locked state using USB Type-C, so that the locked state can be released while power is not supplied to the main control unit 10. Therefore, the information processing system 100 according to one or more embodiments can further improve security in releasing the locked state.

Moreover, in one or more embodiments, if the mutual validity of the laptop PC 1 and the authentication apparatus 2 is verified, the embedded controller 31 further permits the BIOS setting process and the BIOS update process. The authentication apparatus 2 executes the BIOS setting process and the BIOS update process for the laptop PC 1 via the embedded controller 31 using USB Type-C.

Thus, the information processing system 100 according to one or more embodiments can execute the BIOS setting process and the BIOS update process while power is not supplied to the main control unit 10. Therefore, the information processing system 100 according to one or more embodiments can further improve security in the BIOS setting process and the BIOS update process.

Moreover, in one or more embodiments, in the mutual authentication process for verifying the mutual validity of the laptop PC 1 and the authentication apparatus 2, the embedded controller 31 transmits encrypted information obtained by encrypting information including a random number using the public key and a first hash value that is a hash value of the information including the random number, to the authentication apparatus 2 using USB Type-C. The authentication apparatus 2 generates a second hash value that is a hash value of information obtained by decrypting the received encrypted information using the private key, and determines that the laptop PC 1 is valid if the received first hash value and the second hash value match. If the authentication apparatus 2 determines that the laptop PC 1 is valid, the authentication apparatus 2 generates a digital signature based on predetermined information using the private key and transmits the digital signature to the embedded controller 31 using USB Type-C. The embedded controller 31 verifies the validity of the authentication apparatus 2 based on the received digital signature and the public key.

Thus, the information processing system 100 according to one or more embodiments can execute the mutual authentication process for verifying the mutual validity of the laptop PC 1 and the authentication apparatus 2 in a simple and safe manner using a random number.

Moreover, in one or more embodiments, the authentication apparatus 2 generates the digital signature by encrypting a third hash value that is a hash value of the predetermined information using the private key. The embedded controller 31 determines that the authentication apparatus 2 is valid if the third hash value and a fourth hash value obtained by decrypting the received digital signature using the public key match.

Thus, the information processing system 100 according to one or more embodiments can verify the validity of the authentication apparatus 2 in a simple and safe manner.

Moreover, in one or more embodiments, the authentication apparatus 2 and the embedded controller 31 execute the mutual authentication process using the USB Type-C CC signal line.

Thus, by using the USB Type-C CC signal line, the information processing system 100 according to one or more embodiments can easily improve security through the use of the existing interface.

Moreover, in one or more embodiments, the mutual validity of the laptop PC 1 and the authentication apparatus 2 is verified based on the private key stored in the USB device 3 connected to the authentication apparatus 2 and the public key held by the laptop PC 1.

Thus, the information processing system 100 according to one or more embodiments can verify the mutual validity of the laptop PC 1 and the authentication apparatus 2 in a simple and safe manner using the USB device 3.

Moreover, in one or more embodiments, the mutual validity of the laptop PC 1 and the authentication apparatus 2 is verified based on the private key stored in the management server 4 (server apparatus) connected to the authentication apparatus 2 via a network and the public key held by the laptop PC 1.

Thus, the information processing system 100 according to one or more embodiments can verify the mutual validity of the laptop PC 1 and the authentication apparatus 2 in a simple and safe manner using the management server 4 (server apparatus).

The laptop PC 1 (information processing apparatus) according to one or more embodiments is the laptop PC 1 in the information processing system 100 including: the laptop PC 1; and the authentication apparatus 2 connectable to the laptop PC 1 via a USB Type-C interface, and includes the main control unit 10 and the embedded controller 31. The laptop PC 1 holds, out of a private key and a public key of public key cryptography assigned to the laptop PC 1, the public key, and is shipped in a locked state in which startup by an OS is prohibited. The main control unit 10 executes processes based on the OS and BIOS. The embedded controller 31 is a sub-control unit capable of operating in a state in which power is not supplied to the main control unit 10, and releases the locked state if the mutual validity of the laptop PC 1 and the authentication apparatus 2 is verified based on the private key and the public key using USB Type-C.

Thus, the laptop PC 1 (information processing apparatus) according to one or more embodiments can achieve the same effects as the above-described information processing system 100 and improve security.

The information processing method according to one or more embodiments is an information processing method of the information processing system 100 including: the laptop PC 1; and the authentication apparatus 2 connectable to the laptop PC 1 via a USB Type-C interface, and includes a shipment step, a connection step, and a release step. The laptop PC 1 includes: the main control unit 10 that executes processes based on an OS and BIOS; and the embedded controller 31 capable of operating in a state in which power is not supplied to the main control unit 10. In the shipment step, the laptop PC 1 holds, out of a private key and a public key of public key cryptography assigned to the laptop PC 1, the public key, and is shipped in a locked state in which startup by the OS is prohibited. In the connection step, the laptop PC 1 is connected to the authentication apparatus 2 via a USB Type-C interface. In the release step, the embedded controller 31 releases the locked state if the mutual validity of the laptop PC 1 and the authentication apparatus 2 is verified based on the private key and the public key using USB Type-C.

Thus, the information processing method according to one or more embodiments can achieve the same effects as the above-described information processing system 100 and improve security.

The present invention is not limited to the foregoing embodiments and changes can be made without departing from the scope of the present invention.

For example, although the foregoing embodiments describes an example in which the USB device 3 or the management server 4 executes the encryption or decryption process using the private key, the present invention is not limited to such. The authentication apparatus 2 may acquire the private key from the USB device 3 or the management server 4 and execute the encryption or decryption process. The authentication apparatus 2 may include a private key storage unit that stores the private key.

Although the foregoing embodiments describes an example in which the information processing apparatus is the laptop PC 1, the present invention is not limited to such, and other information processing apparatuses such as a tablet terminal apparatus and a desktop PC may be used.

Although the foregoing embodiments describes an example in which the authentication process for mutually verifying validity is executed between the authentication apparatus 2 and the laptop PC 1 (embedded controller 31) using a random number, the present invention is not limited to such, and other methods may be used for the authentication process.

Although the foregoing embodiments describes an example in which a digital signature is used in the process of verifying the validity of the authentication apparatus 2, the present invention is not limited to such, and a process using a random number may be performed as with the process of verifying the validity of the laptop PC 1.

Each component in the foregoing information processing system 100 includes a computer system. Processes in the components in the foregoing information processing system 100 may be performed by recording a program for implementing the functions of the components in the foregoing information processing system 100 on a computer-readable recording medium and causing a computer system to read and execute the program recorded on the recording medium. Herein, the expression “causing a computer system to read and execute the program recorded on the recording medium” includes installing the program in the computer system. The term “computer system” herein includes an OS and hardware such as peripherals.

The “computer system” may include a plurality of computer apparatuses connected via a network such as the Internet, a WAN, a LAN, or a communication line such as a dedicated line. The “computer-readable recording medium” refers to a portable medium such as a flexible disk, a magneto-optical disc, a ROM, or a CD-ROM, or a storage device such as a hard disk embedded in the computer system. Thus, the recording medium storing the program may be a non-transitory recording medium such as a CD-ROM.

The recording medium includes a recording medium internally or externally provided so as to be accessible from a distribution server for distributing the program. A configuration in which the program is divided into a plurality of parts and the components in the information processing system 100 combine the parts after the parts are downloaded at different timings may be adopted, and distribution servers for distributing the parts into which the program is divided may be different. The “computer-readable recording medium” includes a medium that holds the program for a certain period of time, such as a volatile memory (RAN) inside a computer system serving as a server or a client when the program is transmitted via a network. The program may be a program for implementing part of the above-described functions. The program may be a differential file (differential program) that can implement the above-described functions in combination with a program already recorded in the computer system.

Part or all of the above-described functions may be implemented as an integrated circuit such as large scale integration (LSI). The above-described functions may be individually formed as a processor, or partially or wholly integrated into a processor. A method of forming an integrated circuit is not limited to LSI, and may be implemented by a dedicated circuit or a general-purpose processor. If integrated circuit technology that can replace LSI emerges as a result of the advancement of semiconductor technology, an integrated circuit based on such technology may be used.

### DESCRIPTION OF SYMBOLS

1 laptop PC
2 authentication apparatus
3 USB device
4 management server
10 main control unit
11 CPU
12 main memory
13 video subsystem
14 display unit
21 chipset
22 BIOS memory
23 SSD
24 audio system
25 WLAN card
26 USB connector
31 embedded controller (EC)
32 input unit
33 power circuit
34 PD controller
41, 210 NW communication unit
42 server storage unit
43 server control unit
100 information processing system
101 BIOS processing unit
102 OS processing unit
221 BIOS program storage unit
222 setting storage unit
223 lock information storage unit
224 public key storage unit
230 apparatus storage unit
231 setting information storage unit
232 BIOS program storage unit
240 apparatus control unit
241, 311 authentication processing unit
242, 313 BIOS setting unit
312 lock control unit
421 registration information storage unit
NW1 network

What is claimed is:

1. An information processing system comprising:
an information processing apparatus that holds, out of a private key and a public key of public key cryptography assigned to the information processing apparatus, the public key, and is shipped in a locked state in which startup by an operating system (OS) is prohibited; and
a higher-level apparatus connectable to the information processing apparatus via an interface of Universal Serial Bus (USB) Type-C,
wherein the information processing apparatus includes:
a main control unit that executes processes based on the OS and Basic Input/Output System (BIOS); and
a sub-control unit that is capable of operating in a state in which power is not supplied to the main control unit, and releases the locked state if mutual validity of the information processing apparatus and the higher-level apparatus is verified based on the private key and the public key using the USB Type-C.

2. The information processing system according to claim 1, wherein the sub-control unit further permits a process of setting the BIOS and a process of updating the BIOS if the mutual validity of the information processing apparatus and the higher-level apparatus is verified, and
wherein the higher-level apparatus executes the process of setting the BIOS and the process of updating the BIOS for the information processing apparatus via the sub-control unit using the USB Type-C.

3. The information processing system according to claim 1, wherein in a mutual authentication process for verifying the mutual validity of the information processing apparatus and the higher-level apparatus,
the sub-control unit transmits encrypted information obtained by encrypting information including a random number using the public key and a first hash value that is a hash value of the information including the random number to the higher-level apparatus using the USB Type-C,
the higher-level apparatus generates a second hash value that is a hash value of information obtained by decrypting the received encrypted information using the private key, and determines that the information processing apparatus is valid if the received first hash value and the second hash value match,
the higher-level apparatus generates a digital signature based on predetermined information using the private key and transmits the digital signature to the sub-control unit using the USB Type-C, if the higher-level apparatus determines that the information processing apparatus is valid, and
the sub-control unit verifies validity of the higher-level apparatus based on the received digital signature and the public key.

4. The information processing system according to claim 3, wherein the higher-level apparatus generates the digital signature by encrypting a third hash value that is a hash value of the predetermined information using the private key, and
wherein the sub-control unit determines that the higher-level apparatus is valid if the third hash value and a fourth hash value obtained by decrypting the received digital signature using the public key match.

5. The information processing system according to claim 3, wherein the higher-level apparatus and the sub-control unit execute the mutual authentication process using a CC signal line of the USB Type-C.

6. The information processing system according to claim 1, wherein the mutual validity of the information processing apparatus and the higher-level apparatus is verified based on the private key stored in a USB device connected to the higher-level apparatus and the public key held in the information processing apparatus.

7. The information processing system according to claim 1, wherein the mutual validity of the information processing apparatus and the higher-level apparatus is verified based on the private key stored in a server apparatus connected to the higher-level apparatus via a network and the public key held in the information processing apparatus.

8. An information processing apparatus in an information processing system including: the information processing apparatus that holds, out of a private key and a public key of public key cryptography assigned to the information processing apparatus, the public key, and is shipped in a locked state in which startup by an operating system (OS) is prohibited; and a higher-level apparatus connectable to the information processing apparatus via an interface of Universal Serial Bus (USB) Type-C, the information processing apparatus comprising:
a main control unit that executes processes based on the OS and Basic Input/Output System (BIOS); and
a sub-control unit that is capable of operating in a state in which power is not supplied to the main control unit, and releases the locked state if mutual validity of the information processing apparatus and the higher-level apparatus is verified based on the private key and the public key using the USB Type-C.

9. An information processing method of an information processing system including: an information processing apparatus including a main control unit that executes processes based on an operating system (OS) and Basic Input/Output System (BIOS) and a sub-control unit capable of operating in a state in which power is not supplied to the main control unit; and a higher-level apparatus connectable to the information processing apparatus via an interface of Universal Serial Bus (USB) Type-C, the information processing method comprising:
a step in which the information processing apparatus holds, out of a private key and a public key of public key cryptography assigned to the information processing apparatus, the public key, and is shipped in a locked state in which startup by the OS is prohibited;
a step in which the information processing apparatus is connected to the higher-level apparatus via the interface of the USB Type-C; and
a step in which the sub-control unit releases the locked state if mutual validity of the information processing apparatus and the higher-level apparatus is verified based on the private key and the public key using the USB Type-C.
